(19) United States
(12) Patent Application Publication
(10) Pub. No.: US 2009/0246425 A1
(43) Pub. Date: Oct. 1, 2009

(54) Systems And Methods For Auto-Aligning Members Bearing Correlated Patterns

(76) Inventors: William Tong, San Francisco, CA (US); Philip J. Kuekes, Menlo Park, CA (US); Duncan Stewart, Menlo Park, CA (US); Wei Wu, Palo Alto, CA (US); Michael Tan, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/262,068

(22) Filed: Oct. 30, 2008

Related U.S. Application Data
(60) Provisional application No. 61/040,018, filed on Mar. 27, 2008.

(51) Int. Cl. B32B 7/04; B29C 65/00; B29C 43/20

(52) U.S. Cl. 428/33; 264/108; 156/556

(57) ABSTRACT

A method of aligning first and second mating surfaces includes: generating a random or pseudo-random function; convolving the random or pseudo-random function with a spread function to produce a correlated function; forming a pattern of bi-polar material on the first mating surface based on a quantization of the correlated function; and forming a complementary pattern of the bi-polar material on the second mating surface. The complementary patterns exert a force on each other toward a desired alignment of the first and second mating surfaces. A system includes a first member having a first correlated pattern of material disposed on a first mating surface; and a second member having a second correlated pattern of material disposed on a second mating surface, wherein the second correlated pattern is complementary to the first correlated pattern. The first and second correlated patterns interact to facilitate a desired alignment of the first and second members.

### CROSS-REFERENCE TO RELATED APPLICATION

The present application claims priority from provisional application Ser. No. 61/040,018, filed Mar. 27, 2008, the contents of which are incorporated herein by reference in their entirety.

### BACKGROUND

In a wide variety of applications, a method of aligning two or more surfaces or members may be needed. Sometimes this alignment is to be very precise, as in nanotechnology applications. In other cases, the alignment needed is on a macroscopic scale.

While aligning members is so frequently needed in many diverse applications, many existing methods for aligning two members, such as optical alignment systems, may not have the desired speed or accuracy. Many existing methods of aligning two members may also not easily scale as needed by the variety of possible applications.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIGS. 1A and 1B are perspective views of an illustrative system for aligning two members according to principles described herein.

FIG. 1C illustrates a method of producing a pattern based on a spread function that will facilitate alignment of two members according to principles described herein.

FIGS. 2A and 2B are cross-sectional views of an illustrative system for aligning two members according to principles described herein.

FIGS. 3A and 3B are graphical representations of illustrative correlation functions of correlated patterns according to principles described herein.

FIGS. 4A and 4B are cross-sectional views of an illustrative system for aligning two members according to principles described herein.

FIGS. 5A and 5B are graphical representations of illustrative correlation functions of correlated patterns according to principles described herein.

FIGS. 6A and 6B are cross-sectional views of an illustrative system for aligning two members according to principles described herein.

FIGS. 7A and 7B are perspective views of illustrative two-dimensional correlated pattern of material on a mating surface of a member according to principles described herein.

FIG. 8 is a diagram of attractive forces between two illustrative two-dimensional correlated patterns of material of magnetic poles according to principles described herein.

FIGS. 9A and 9B are perspective views of an illustrative system for aligning two members according to principles described herein.

FIG. 10 is a diagrammatic view of an illustrative system for aligning two members according to principles described herein.

FIG. 11 is a block diagram of an illustrative method of aligning two members according to principles described herein.

Throughout the drawings, identical reference numbers designate similar, but not necessarily identical, elements.

### DETAILED DESCRIPTION

Due to the high cost of existing alignment techniques, it would be desirable to provide a low-cost method for facilitating automatic surface alignment in a variety of applications. A significant factor in reducing the cost of alignment may involve eliminating the need for a skilled operator. Instead of involving a skilled operator, it may be beneficial and more efficient to provide a system in which surfaces automatically align themselves according to desired specifications.

To accomplish the above and other goals, the present specification discloses illustrative systems and methods of automatically aligning the surfaces of two mating members. The systems and methods may utilize correlated patterns of material disposed on the mating surfaces of the members. The patterns may be configured to orient the mating surfaces into a desired alignment as the members are brought together.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to illustrative system and methods.

### Illustrative System

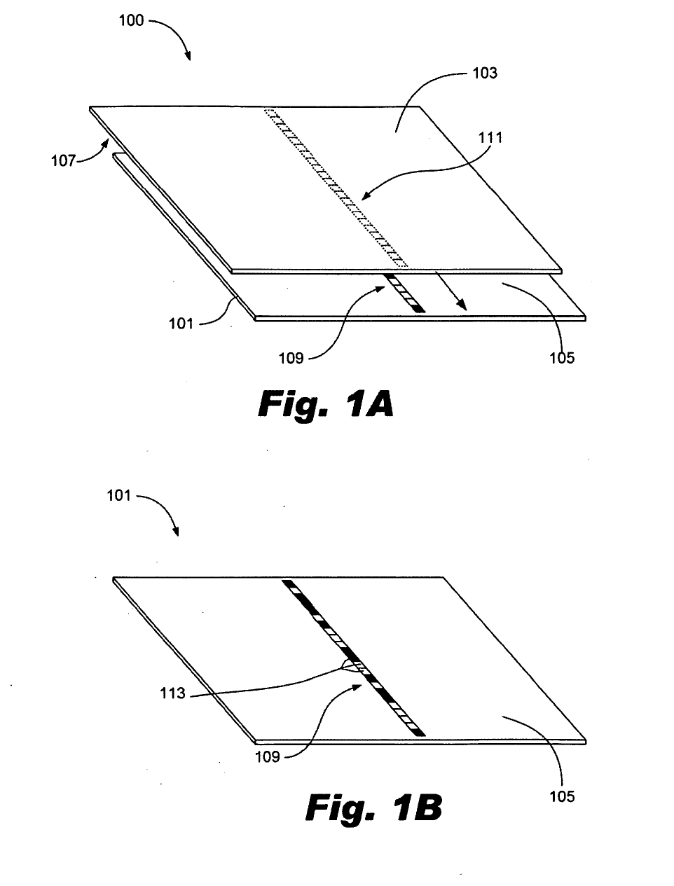

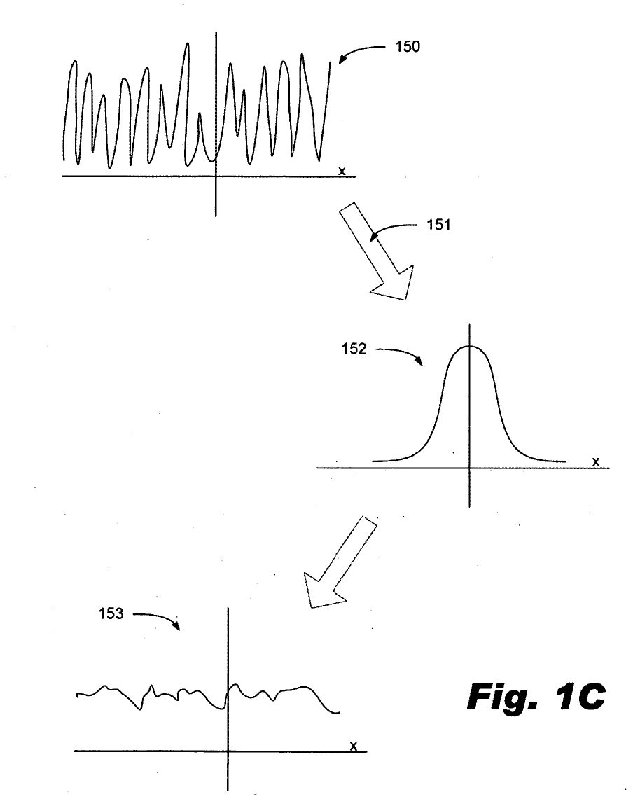

Referring now to FIGS. 1A-1B, an illustrative system (100) is shown in which a first member (101) and a second member (103) are configured to become automatically oriented according to a desired alignment as the first and second members (101, 103) are brought together. The members (101, 103) may generically represent any two members for which precise alignment is needed in a nano-technology application.

It will be further understood that while the first and second members (101, 103) illustrated in the examples of the present specification and its accompanying figures may be geometrically simple for the purpose of clarity, any suitable shape and/or material for mating members may be used in conjunction with the principles described in the present specification. For example, the principles of the present specification may be applied to the alignment of mating members in the fabrication and/or operation of nano-devices or other nanotechnology-related applications.

As shown in FIG. 1A, each of the first and second members (101, 103) may include a mating surface (105, 107, respectively). The respective mating surfaces (105, 107) of the two members (101, 103) may be configured to engage each other or come into close proximity to each other. However, it may be desirable that the first and second members (101, 103) obtain a desired alignment when they are brought together, as previously discussed. For this reason, each of the mating surfaces (105, 107) may have a correlated pattern of material (109, 111, respectively) disposed thereon.

As used herein and in the appended claims, the term “correlated pattern” will refer to a pattern that is correlated with a complementary pattern on an opposite member, the correlation resulting from convolution of a random or pseudo-random pattern with a spread function as described herein.

These correlated patterns of material (109, 111) on the mating surfaces (105, 107) are configured to match or complement each other such that when the first and second members (101, 103) are brought together, the first and second mating surfaces (105, 107) are oriented into a desired alignment by the matching of the complementary, correlated patterns.

The material(s) used to create the correlated patterns of material (109, 111) on the mating surfaces (105, 107) may create an array of bipolar elements within the correlated patterns of material (109, 111) such that attractive and/or repulsive forces between the correlated patterns of material (109, 111) in each of the mating surfaces (105, 107) may be used to create an inherent propensity between the correlated patterns of material (109, 111) to be aligned in a certain way.

As shown in FIG. 1B, the correlated patterns of material (109, 111) may include a number of distinct and separate portions (113) of polar material. For example, the polar material may be north and south poles of a magnetic material, or hydrophilic and hydrophobic chemicals, as will be explained in more detail below. In other embodiments, the correlated patterns of material (109, 111) may include patterns of complementary mechanical features, as also explained in more detail below.

FIG. 1C illustrates a method of producing a pattern based on a spread function that will facilitate alignment of two members according to principles described herein. As indicated, the correlated pattern on each member being aligned is the complement or exact opposite of the pattern on the other member. Within this complementary relationship, the correlated pattern of material on either mating surfaces of the members being aligned may be a purely random arrangement of the two bipolar elements used in that embodiment, e.g., north and south magnetic poles. However, if the pattern is based on a purely random or pseudo-random arrangement, matching the two patterns may be time consuming as needed to find only that specific relative alignment in which the random complementary patterns on the two members are properly registered

To facilitate the alignment of the two members, the bipolar elements in the pattern may have some correlation rather than a purely random pattern. Where this is the case, the bipolar elements will exert a force toward the proper registration of the two patterns even before that desired registration is completely achieved.

As shown in FIG. 1C, the creation of a correlated pattern as described herein may begin with a random function (150). This can be produced with a random number generator. Next, the random function (150) is convolved (151) with a spread function (152).

Convolution (151) is a known mathematical operation that takes two functions f and g and produces a third function that, in a sense, represents the amount of overlap between f and a reversed and translated version of g. The convolution of f and g is written f*g and can is defined as the integral of the product of the two functions after one is reversed and shifted. Thus, convolution (151) is a particular kind of integral transform as will be described in more detail below.

The spread function (152) has a single maximum or minimum, with a curve directed to the extremum from both directions. Consequently, this property of moving to an extremum will be imparted to the function resulting from the convolution (151). The extremum will represent that point at which the complementary patterns on the mating surfaces of the members being aligned are properly registered.

In the following equation, the random function (150) is f, and the spread function (152) is g. Then, for example, by convolution theorem, the function (152) resulting from the convolution (151) is represented by p.

p=FT(R*S)

where FT is the Fourier transform operator;

R is FT(f); and

S is FT (g).

The function p (153) resulting from the convolution (151) can be unique, because it is based in part on the random function (150). It is also deterministic in that complementary patterns of bipolar elements corresponding to the convolved function (153) will exert a mutual force on each other corresponding to the extremum of the spread function (152) which is also the alignment at which the patterns are properly registered.

The function p (153) is then used to generate the two correlated complementary patterns that are formed on the two members to be aligned. For example, the mean value of the function (153) is determined. Then, depending on the number of individual elements desired in the final pattern, the function (153) is divided into a corresponding number of increments. For each increment, an average or representative value is determined which is then compared to the mean of the function (153). If the average or representative value is at or above the mean of the function, a first bipolar element is chosen for that portion of the pattern. If the average or representative value is below the mean of the function, the second bipolar element is chosen instead for that portion of the pattern. This process continues until each increment of the function (153) has been quantized into one or the other of the bipolar elements being used to form the pattern. The result is a pattern that is formed on one of the two members or mating surfaces to be aligned.

The pattern for the other of the two members or mating surfaces is then the complement or exact opposite of the pattern produced by quantizing the function (153). This complementary pattern is then formed on the other of the two members or mating surfaces.

Consequently, using the method illustrated in FIG. 1C, complementary patterns of bipolar elements may be prepared on mating surfaces of members to be aligned where the patterns facilitate an alignment by exerting a force toward the desired alignment before that alignment is achieved. The slope of the spread function approaching its extremum will correspond to the strength of this force toward the desired alignment. This approach may greatly reduce the time and effort required to align the members.

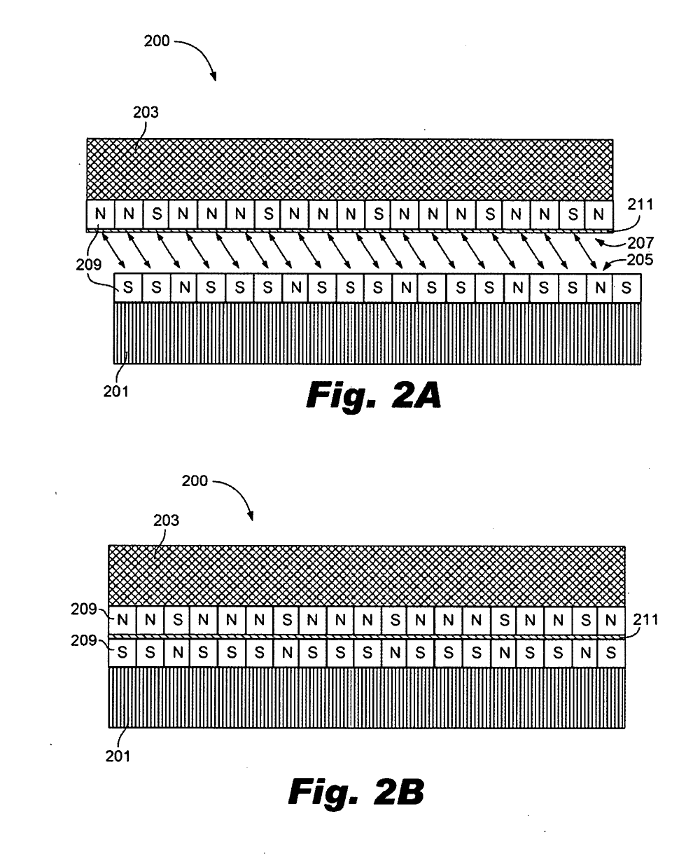

Referring now to FIGS. 2A-2B, a cross-sectional view of an illustrative system (200) according to the principles described herein is shown. The system (200) may include first and second members (201, 203) having correlated patterns (205, 207) that are formed with portions (209) of magnetically polar material disposed on corresponding mating surfaces. The portions (209) may include any magnetic or magnetizable material that may suit a particular application. Examples of suitable magnetic materials include, but are not limited to, ferromagnetics, anti-ferromagnetics, and ferrimagnetics. Various examples of these types of magnetic materials include, but are not limited to, iron, cobalt, nickel, and rare earth metals, ceramics, other ferromagnetic materials, ferrites, transition metal oxides, fluorides, and chlorides having a rutile-type structure, as well as Fe-containing perovskites, and combinations thereof. The outer surface of each of the portions (209) may be magnetized as either a north or a south pole. The pattern in which north and south polar portions (209) are distributed along the mating surfaces of the members (201, 203) defines a correlated pattern (205, 207) characteristic of respective members (201, 203).

Due the fact that opposite magnetic poles attract each other, the correlated patterns of material (205, 207) may be configured to complement each other. In other words, each of the first and second members (201, 203) may have a correlated pattern that is the exact opposite of the pattern on the other member. Due to the non-repeating nature of the correlated patterns of material (205, 207), there may be only one stable position in which each portion (209) is closest to another portion (209) having an opposite magnetic polarity. When the first and second members (201, 203) are not in a desired alignment state, as shown in FIG. 2A, under magnetic laws, the correlated patterns (205, 207) may be naturally guided to the desired aligned position by magnetic forces illustrated by the arrows as the first and second members (201, 203) are brought closer together.

FIG. 2B shows the two members (201, 203) mated together and the correlated patterns (205, 207) maintaining a stable position with each of the portions (209) of the correlated patterns (205, 207) being directly opposite a corresponding portion (209) of opposite magnetic polarity. As such, the mating surfaces of the first and second members (201, 203) may be brought into the desired alignment.

The portions (209) of the correlated patterns (205, 207) may be magnetized during fabrication of the first and second members (201, 203) by a direct writing process similar to that used in writing digital data to a hard disk. In such a writing process, an electromagnetic head is passed over each of the portions (209) of the pattern and exerts a magnetic field over each portion (209) determined by the desired polarity of each of the portions (209). This method may be particularly useful in high-security applications, where unique patterns prevent the unauthorized use of the two members (201, 203). For example, in some cases, one of the members (201, 203) may be a component in a piece of manufacturing equipment, and another of the members (201, 203) may be a component of a device manufactured by the process.

As described herein, each complementary pattern can be unique because each can be based on a unique random function. The uniqueness of each set of complementary correlated patterns can prevent the alignment of two parts not designed for each other. If one accidentally or intentionally tries to align two parts, each having a correlated pattern, but where the two patterns are not complementary to each other, there will be no matching or settling of the patterns into an aligned state. Consequently, the error of trying to align to parts not intended for each other can be quickly realized.

Additionally, unique complementary correlated patterns (205, 207) used on the first and second members (201, 203) may prevent or deter a user from attempting to utilize one of the members (201, 203) with unauthorized manufacturing equipment or to manufacture an unauthorized device using one of the members (201, 203). In such cases, a uniquely written correlated pattern (205, 207) may be used as a “lock-and-key” approach to security.

In other embodiments, security and unique patterning may not be very significant concerns. In such embodiments, the portions (209) of the correlated patterns (205, 207) may be magnetized by direct contact to a magnetic stamp having the desired pattern. This may be performed in a somewhat similar manner to the way a stamp is used in imprint lithography. This method may be preferable when low-cost mass production capabilities are desired.

At least one of the first and second members (201, 203) may include a thin coating (211) disposed over its corresponding mating surface to facilitate the smooth sliding of the mating surfaces against each other to reach the desired alignment. This coating (211) may include a polymer substance, such as Teflon, or any other lubricating substance as may fit a particular application. The coating (211) may be disposed over the at least one mating surface using any suitable technique, as may fit a particular application.

However, the coefficient of friction between the first and second members (201, 203) should be non-zero. Some friction between the first and second members (201, 203) will help control lateral movement of the members (201, 203) relative to each other and facilitate the alignment of the members and the matching of complementary correlated patterns, irrespective of the bi-polar material used to form the patterns.

The coefficient of friction between the first and second members (201, 203) relates the lateral force on the members to the attractive force between the complementary patterns. The attractive force between the complementary patterns is typically normal to surfaces of the members (201, 203) and the lateral force and movement of the members (201, 203). Specifically, the coefficient of friction multiplied by the normal force equals the frictional force. Consequently, a non-zero coefficient of friction provides a lateral frictional force that helps achieve alignment. For example, as the first and second members move with respect to each other, for example, sliding over each other, some amount of friction between the members will thus help facilitate the complementary patterns from sliding past each other, causing the members to slow and stop with the desired alignment where the complementary patterns are matched.

The coefficient of friction can be selected or controlled by the selection of surface materials or coatings for the first and second members (201, 203). The coefficient of friction can also be controlled by providing a texture on the surfaces of the first and second members (201, 203).

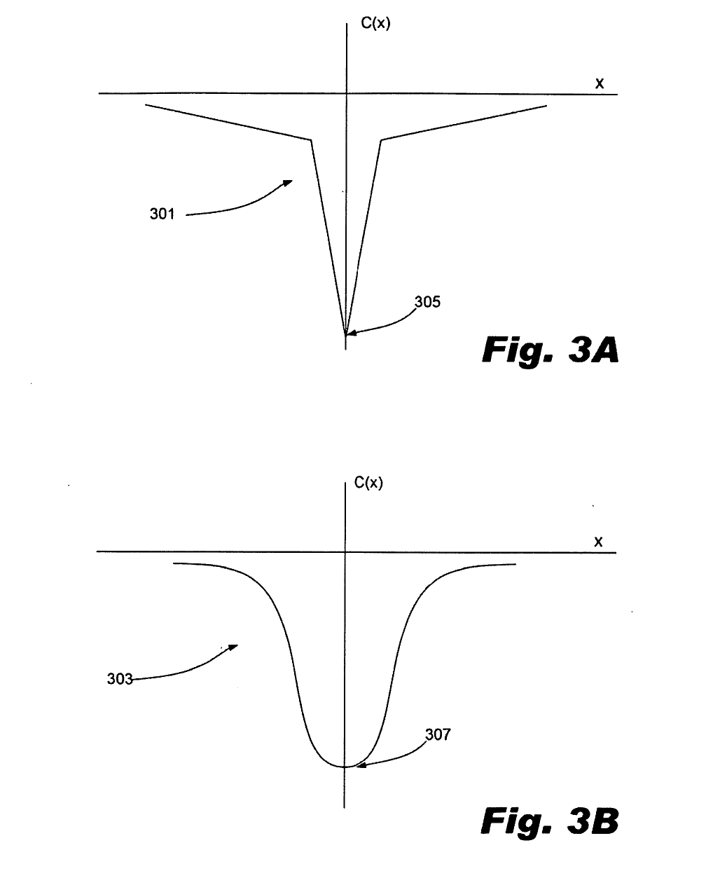

Referring now to FIGS. 3A-3B, illustrative correlation functions (301, 303) are shown that model the similarity of the magnetic fields produced by two members (201, 203, FIG. 2) having complementary correlated magnetic patterns (205, 207, FIG. 2) disposed thereon. The illustrative correlation functions (301, 303) are modeled as a function of x, or the degree of alignment between the mating surfaces of the two members (201, 203, FIG. 2). Thus, at x=0, the mating surfaces of the two members (201, 203, FIG. 2) may be perfectly aligned according to the desired alignment. Positive values of x indicate a misalignment in one direction, and negative values of x indicate a misalignment in an opposite direction.

The correlation function values C(x) indicate the degree of similarity between the total magnetic fields produced by the two members (201, 203, FIG. 2) integrated over all feasible values of x. Thus, the higher a value for C(x) is, the more similar the total magnetic fields produced by the two members (201, 203, FIG. 2) are over all consequential space. Likewise, the lower a value for C(x) is, the more dissimilar the total magnetic fields produced by the two members (201, 203, FIG. 2) are over all consequential space.

Since opposite poles in magnets attract, the most stable position magnetically for the correlated magnetic patterns (205, 207, FIG. 2) of the present example is the point at which the total magnetic fields produced by the two members (201, 203, FIG. 2) over all consequential space are the most opposite, or the most dissimilar. Thus, each of the correlation functions (301, 303) may approach a minimum value (305, 307) at x=0, or the point at which the two members (201, 203, FIG. 2) are exactly aligned according to the desired alignment. Similarly, the degree of magnetic force guiding the two members (201, 203, FIG. 2) toward the desired alignment may be proportional to the slope of the correlation functions (301, 303) at the value of x representing the degree and direction of misalignment between the two members (201, 203, FIG. 2).

The correlation functions (301, 303) created by different correlated patterns (205, 207, FIG. 2) may be dependent on, and therefore manipulated by, altering the correlated magnetic patterns (205, 207, FIG. 2) present on the mating surfaces of the two members (201, 203, FIG. 2). This is done according to the desired characteristics of a particular application.

As shown in FIGS. 3A and 3B, various correlation functions may be designed to have an increasing slope from both directions toward the vertical axis, which represents the desired alignment. Such a correlation function represents that the attractive force between the members being aligned increases as their relative positions approach the desired alignment. The shape of the correlation function may further describe the operation of the forces between the correlated patterns on the members being aligned. For example, the function in FIG. 3A represents a force between the aligning members that is relative weak until the desired alignment is nearly achieved. Then, as shown in FIG. 3A, the correlation function provides a strong “snap” and lock when proper alignment between the mating surfaces of the two members (201, 203, FIG. 2) is achieved. The “snap” at alignment corresponds to the sharp valley that converges on the vertical axis in the curve (301). Alternatively, as shown in FIG. 3B, a different correlation function (303) may be designed. This correlation function will produce a stronger attractive force as the two members come into near-alignment with a relatively weaker lock or snap when the final desired alignment is achieved. The “lock” of this function corresponds to the rounded trough at the bottom of the curve (303).

In order to achieve the goal of creating a non-deterministic correlated pattern (205, 207, FIG. 2) having a desired correlation function (303), several approaches may be taken. In some embodiments, this may be accomplished by producing a non-deterministic sequence, such as from a random number generator, and convolving the non-deterministic sequence with the desired correlation function. The resulting correlated pattern may then be translated to the mating surfaces of the two members (201, 203, FIG. 2) according to the desired features of a particular application.

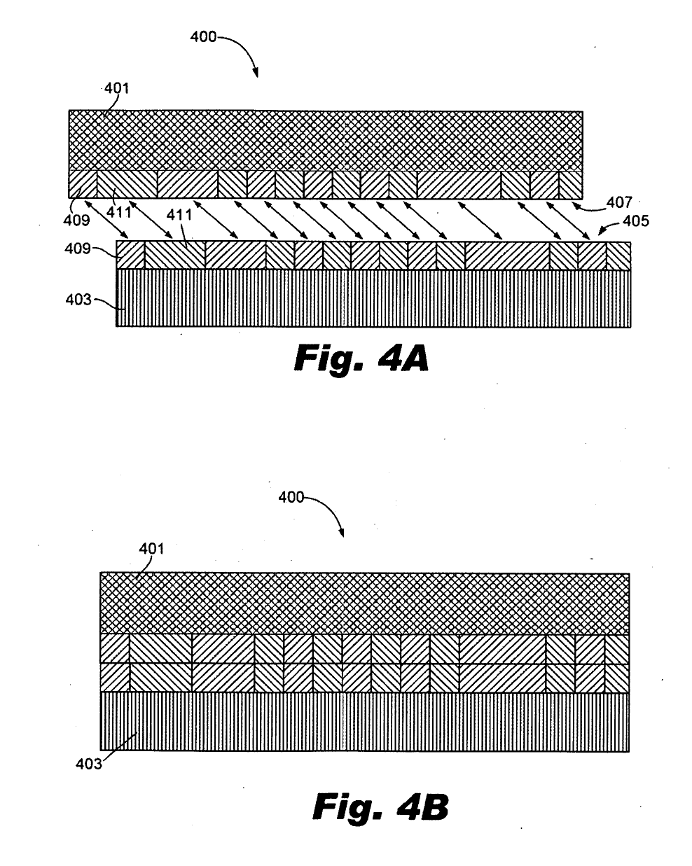

Referring now to FIGS. 4A-4B, another exemplary system (400) is shown having first and second members (401, 403) that have complementary first and second correlated patterns (405, 407) disposed on corresponding mating surfaces. The correlated patterns (405, 407) of the present embodiment include alternating hydrophilic portions (409) and hydrophobic portions (411). The unique characteristics of the correlated patterns (405, 407) may be determined by the relative sizes of the hydrophilic and hydrophobic portions (409, 411).

Hydrophilic materials tend to attract other hydrophilic materials and repel hydrophobic materials. Likewise, hydrophobic materials tend to attract other hydrophobic materials and repel hydrophilic materials. Due to this property, the correlated patterns (405, 407) of the first and second members (401, 403) may be configured to match each other. In other words, each of the first and second members (401, 403) may have exactly the opposite correlated pattern as the other member when viewed in cross-section.

Similar to the magnetic embodiment of FIGS. 2A-2B, due to the non-repeating nature of the correlated patterns (405, 407), there may be only one stable position in which each portion (409, 411) is adjacent to another portion (409, 411) having a similar behavior towards water. When the first and second members (401, 403) are not in a desired alignment state, as shown in FIG. 4A, under chemical laws, the correlated patterns (405, 407) may be naturally guided to the desired alignment as the first and second members (401, 403) are brought closer together. The forces involved are illustrated by the arrows in FIG. 4A.

FIG. 4B shows the two members (401, 403) properly aligned together and the correlated patterns (405, 407) maintaining a stable position with each of the portions (409, 411) being directly opposite a corresponding portion (409, 411) of similar chemical behavior towards water. As such, the mating surfaces of the first and second members (401, 403) may be brought into the desired alignment.

The hydrophilic and hydrophobic portions (409, 411) of the correlated patterns (405, 407) may be created on the mating surfaces of the first and second members (401, 403) using a variety of techniques. For example, the hydrophilic and hydrophobic portions (409, 411) of the correlated patterns (405, 407) may be created on the mating surfaces of the first and second members (401, 403) by using conventional photolithography or imprinting techniques to deposit hydrophilic and hydrophobic chemicals on the surfaces as needed to form the complementary patterns.

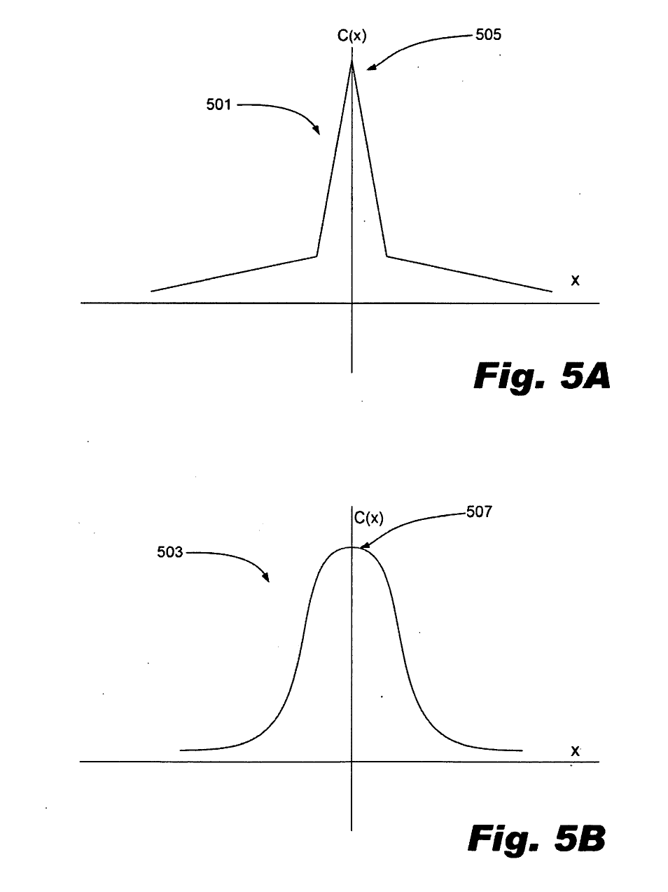

Referring now to FIGS. 5A-5B, illustrative correlation functions (501, 503) are shown that model the integrated similarity of the chemical nature of correlated patterns (405, 407, FIG. 4) utilizing alternating hydrophilic portions (409, FIG. 4) and hydrophobic portions (411, FIG. 4) at all linear points in a space of consequence.

The correlation function values C(x) indicate the degree of similarity between the total chemical characteristics of the correlated patterns (405, 407, FIG. 4) of the two members (401, 403, FIG. 4), as integrated over all feasible values of x. Thus, the higher a value for C(x) is, the more similar are the hydrophilic or hydrophobic nature of the correlated patterns (405, 407) in the two members (401, 403, FIG. 4), integrated over all consequential space. Likewise, the lower a value for C(x) is, the more dissimilar is the hydrophilic or hydrophobic nature of the correlated patterns (405, 407) produced by the two members (201, 203, FIG. 2) as integrated over all consequential space.

Since mutually hydrophilic portions (409, FIG. 4) and mutually hydrophobic portions (411, FIG. 4) attract each other, the most stable position chemically for the correlated chemical patterns (405, 407, FIG. 4) of the present example is the point at which the hydrophilic or hydrophobic characteristics of the two members (401, 403, FIG. 4) over all consequential space are the most similar. Thus, each of the correlation functions (501, 503) may approach a maximum value (505, 507) at x=0, or the point at which the two members (401, 403, FIG. 4) are exactly aligned according to the desired alignment. Similarly, the degree of chemical force guiding the two members (401, 403, FIG. 4) toward the desired alignment may be proportional to the slope of the correlation functions (501, 503) at the value of x representing the degree and direction of misalignment between the two members (401, 403, FIG. 4).

As described previously, the correlation functions (501, 503) created by different correlated patterns (405, 407, FIG. 4) may be dependent on, and therefore manipulated by, altering the correlated hydrophobic/hydrophilic patterns (405, 407, FIG. 4) present on the mating surfaces of the two members (401, 403, FIG. 4), according to the desired characteristics of a particular application.

As shown in FIG. 5A, similar to the correlation function (301, FIG. 3A) described previously, a correlation function (501) may be designed to have an increasing slope such that the attraction force towards the desired alignment increases to produce a “snap” effect as the mating surfaces of the two members (401, 403, FIG. 4) come closer together and approach the desired alignment. The “snap” effect corresponds to the peak or spike of the curve (501).

As shown in FIG. 5B, similar to the correlation function (303, FIG. 3B) described previously, a correlation function (503) may alternatively be designed to produce a stronger attraction toward the desired alignment that is stronger further away from the desired alignment. Then, the correlation function (503) produces a relatively weaker “lock” when the mating surfaces of the two members (401, 403, FIG. 4) reach the desired alignment. The “lock” at alignment corresponds to the rounded peak of the curve (503).

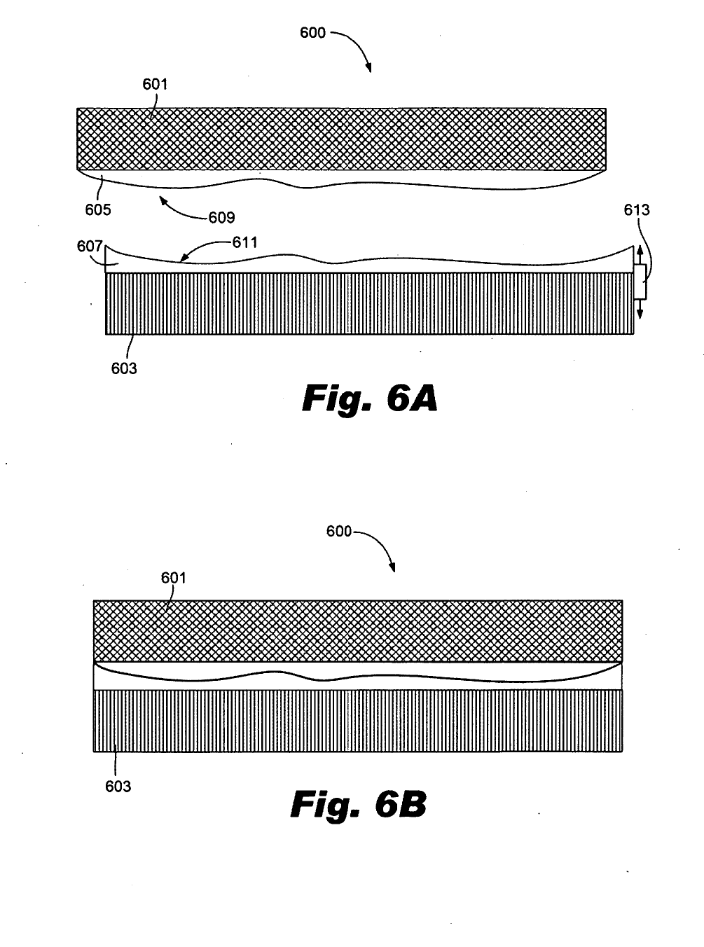

Referring now to FIGS. 6A-6B, another illustrative system (600) is shown. The system (600) may include first and second members (601, 603) having correlated patterns (605, 607) disposed on corresponding mating surfaces. The correlated patterns (605, 607) of the present example may include mechanical features (609, 611) formed in a material deposited on the first and second members (601, 603). Similar to the correlated patterns of other embodiments, the correlated patterns (605, 607) of the present example may be configured to complement each other such that the mating surfaces of the first and second members (601, 603) are drawn toward and automatically achieve a desired alignment when the first and second members (601, 603) are brought together. This may be done using, for example, complementary slopes, peaks, troughs, and other features. Unlike some magnetic and chemical embodiments, the mechanical features (609, 611) of the present example may extend in more than two states (e.g. more than two dimensions and shapes of the mechanical features may be expressed).

FIG. 6A shows the first and second members (601, 603) in an unmated state of misalignment. FIG. 6B shows the first and second members (601, 603) oriented in a desired alignment due to the sliding forces between the first and second members (601, 603) caused by the correlated patterns (605, 607).

Additionally, in some embodiments, a small mechanical oscillator (613) may be disposed on at least one of the first and second members (601, 603) near at least one of the correlated patterns (605, 607) to prevent the mechanical features (609, 611) of the correlated patterns (605, 607) from binding to each other prior to obtaining the desired alignment. Any suitable mechanical oscillator (613) may be used according to a particular application, including, but not limited to, piezoelectric oscillators, springs, pendulums, and the like.

The mechanical features (609, 611) in the correlated patterns (605, 607) may be formed in a material deposited on the mating surfaces of the two members (601, 603) and molded or embossed according to the desired correlated patterns (605, 607). In some embodiments, a soft deformable polymer or other material may be deposited on the mating surfaces of the two members (601, 603) and embossed according to the desired correlated pattern.

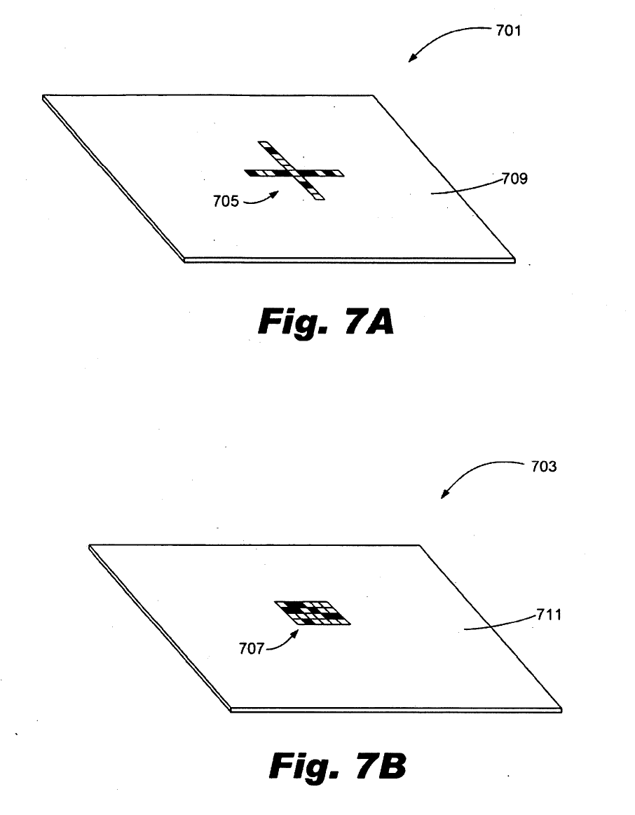

Referring now to FIGS. 7A-7B, illustrative mating members (701, 703) are shown having two-dimensional correlated patterns (705, 707) disposed on corresponding mating surfaces (709, 711). Correlating two-dimensional correlated patterns (705, 707) may be used to achieve a desired two-dimensional alignment between two members.

FIG. 7A shows one possible embodiment of a two-dimensional correlated pattern (705). FIG. 7B shows another possible embodiment of a two-dimensional correlated pattern (707), according to principles described previously.

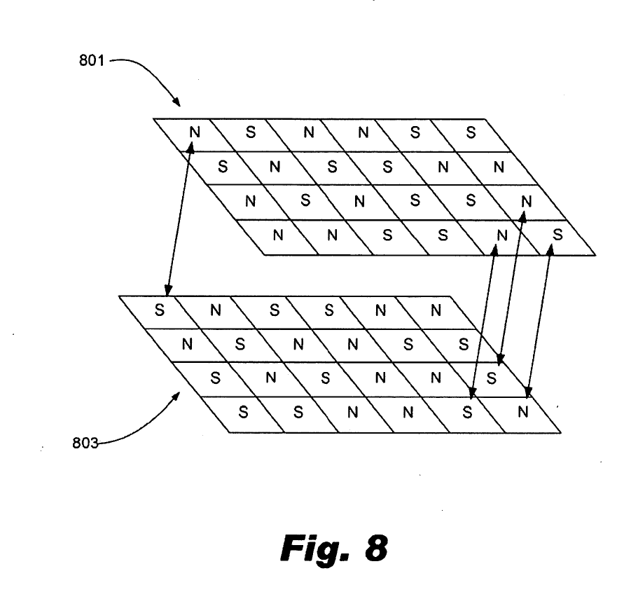

Referring now to FIG. 8, illustrative attractive forces between two illustrative complementary two-dimensional correlated magnetic patterns (801, 803) are shown. Such attractive forces between opposite magnetic poles may be used to achieve a desired alignment between two members in two dimensions, as described above.

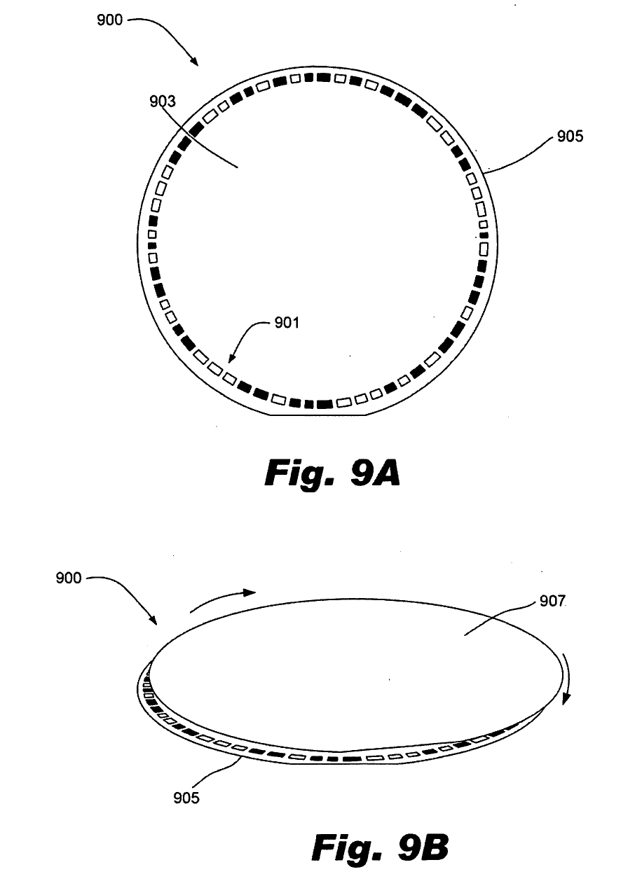

Referring now to FIGS. 9A-9B, an illustrative system (900) is shown in which correlated patterns (e.g., 901) consistent with principles described previously are disposed in a ring or annular geometry on mating surfaces (903) of respective first and second members (905, 907). The ring geometry may be used to achieve a desired rotational alignment between the two members (905, 907). The desired alignment is performed as described above by allowing the forces between the complementary patterns to align the patterns (e.g., 901) and, consequently, the respective members (905, 907).

The arrows in FIG. 9B illustrated relative rotation of the respective members (905, 907). This rotation eventually achieves the desired aligned state in which the complimentary patterns (e.g., 901) on the respective members are registered with each other.

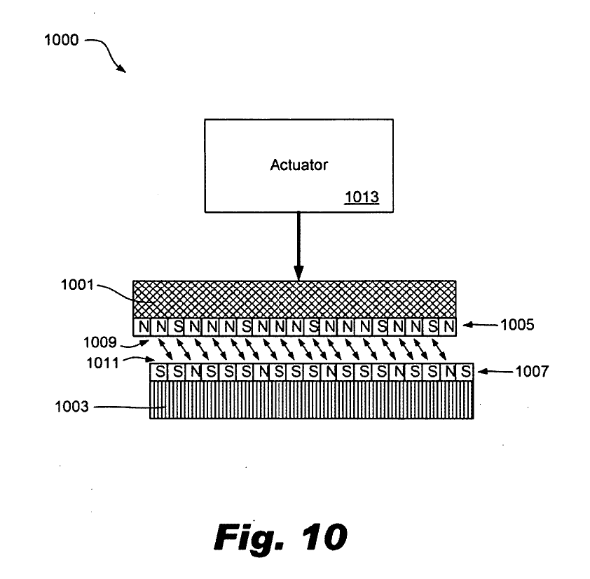

Referring now to FIG. 10, an illustrative system (1000) is shown that precisely aligns first and second members (1001, 1003) as described herein. As in the examples of the present specification, first and second correlated patterns (1005, 1007, respectively) are disposed on mating surfaces (1009, 1011, respectively) of the first and second members (1001, 1003) according to principles described herein.

An actuator (1013) may be configured to impart mechanical motion to at least one of the first and second members (1001, 1003) such that the mating surfaces (1009, 1011) of the first and second members (1001, 1003) are brought together. As the first and second mating surfaces (1009, 1011) are brought together, the correlated patterns (1005, 1007) on the mating surfaces (1009, 1011) may be configured to orient the mating surfaces (1009, 1011) according to a desired alignment.

In some embodiments, a plurality of actuators (1013) may be used to bring the first and second mating surfaces (1009, 1011) together. Any suitable actuator may be used, as may fit a particular application. Examples of suitable actuators include, but are not limited to, mechanical actuators, electric motors, hydraulic actuators, and combinations thereof.

### Illustrative Methods

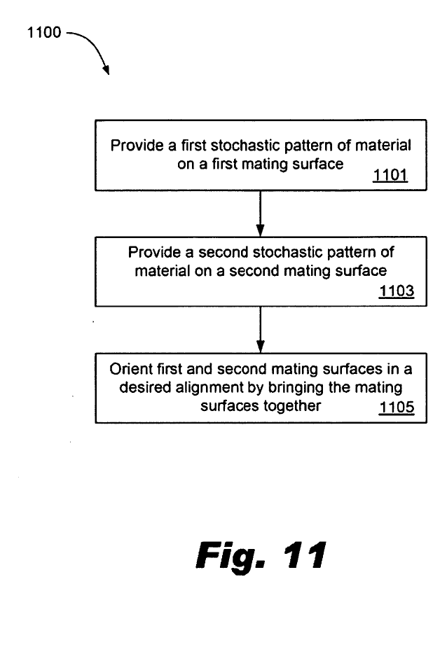

Referring now to FIG. 11, an illustrative method (1100) is shown according with the principles described herein. The method (1100) Includes depositing or otherwise forming (step 1101) a first correlated pattern of material on a first mating surface for a first member. A second correlated pattern of material is then deposited or otherwise formed (step 1103) on a second mating surface of a second member.

In some embodiments, deposition (steps 1101, 1103) of correlated patterns of material may include selectively magnetizing portions of material deposited on the mating surfaces. In other embodiments, the deposition (steps 1101, 1103) of the correlated patterns of material may include selectively embossing complementary mechanical structures into a deformable layer on each of the mating surfaces. In still other embodiments, the deposition (steps 1101, 1103) of the correlated patterns of material may include selectively depositing patterns of hydrophilic and hydrophobic chemicals.

The first and second mating surfaces may then be oriented (step 1105) in a desired alignment by bringing the mating surfaces together. As described herein, the patterns will then exert or respond to forces that bring the patterns, and consequently the members on which they are respectively disposed, into the desired alignment with each other.

As will be appreciated by those skilled in the art, the principles described herein may also be applied to a variety of security applications. For example, a lock may consist of a member with a correlated pattern as described herein. The lock is actuated or “opened” when a member, i.e., a key, bearing the corresponding correlated pattern is aligned and matched with the pattern on the lock member according to the principles described herein. Various different means and methods which will be apparent with the benefit of this disclosure, may be used to detect when the correspondingly patterned member is mated with the first or “lock” member.

The preceding description has been presented only to illustrate and describe embodiments and examples of the principles described. This description is not intended to be exhaustive or to limit these principles to any precise form disclosed. Many modifications and-variations are possible in light of the above teaching.

What is claimed is:

1. A method of aligning first and second mating surfaces, said method comprising:
generating a random or pseudo-random function;
convolving said random or pseudo-random function with a spread function to produce a correlated function;
forming a pattern of bi-polar material on said first mating surface based on a quantization of said correlated function; and
forming a complementary pattern of said bi-polar material on said second mating surface;
wherein said complementary patterns exert a force on each other toward a desired alignment of said first and second mating surfaces.

2. The method of claim 1, further comprising controlling said force as a function of distance from said desired alignment by changing a shape of said spread function.

3. The method of claim 1, further comprising quantizing said correlated function by comparing a representative value of each of a number of increments of said correlated function with a mean value for said correlated function.

4. The method of claim 1, wherein said bi-polar material comprises north and south magnetic poles.

5. The method of claim 1, wherein said bi-polar material comprises hydrophobic and hydrophilic chemicals.

6. The method of claim 1, further comprising forming said complementary patterns with an angular geometry to facilitate angular alignment of said mating surfaces.

7. The method of claim 1, further comprising selecting material for said first and second mating surfaces to control a coefficient of friction between said first and second mating surfaces.

8. A system comprising:
a first member having a first correlated pattern of material disposed on a first mating surface; and
a second member having a second correlated pattern of material disposed on a second mating surface, wherein said second correlated pattern is complementary to said first correlated pattern;
wherein said first and second correlated patterns interact to facilitate a desired alignment of said first and second members.

9. The system of claim 8, wherein said first and second correlated patterns of material comprise complementary patterns of magnetic poles.

10. The system of claim 8, wherein said first and second correlated patterns of material comprise complementary, mutually-attractive patterns of hydrophobic and hydrophilic chemicals.

11. The system of claim 8, wherein said first and second correlated patterns of material comprise complementary mechanical features.

12. The system of claim 11, wherein at least one of said members comprises a mechanical oscillator configured to prevent said mechanical features from binding together at an undesired alignment.

13. The system of claim 8, wherein at least one of said mating surfaces comprises a material providing a desired coefficient of friction to control sliding between said mating surfaces.

14. The system of claim 13, said material comprises a coating on at least one of said mating surfaces.

15. The system of claim 8, wherein each of said first and second correlated patterns has an annular geometry configured to orient said members into a desired rotational alignment.

16. A system, comprising:
a first member having a first correlated pattern of material disposed on a first mating surface; and
a second member having a second correlated pattern of material disposed on a second mating surface; and
an actuator configured to bring said first and second members together;
wherein said first and second correlated patterns of material are configured to orient said mating surfaces into a desired alignment as said first and second members are brought together.

17. The system of claim 16, wherein said first and second correlated patterns of material comprise complementary patterns of magnetic poles.

18. The system of claim 16, wherein said first and second correlated patterns of material comprise mutually attractive patterns of hydrophobic and hydrophilic chemicals.

19. The system of claim 16, wherein said first and second correlated patterns of material comprise complementary mechanical features.

20. The system of claim 19, wherein at least one of said members comprises a mechanical oscillator configured to prevent said mechanical features from binding together at an undesired alignment.

21. The system of claim 16, wherein at least one of said mating surfaces comprises a coating of a material configured to facilitate sliding between said mating surfaces.

22. The system of claim 16, wherein each of said first and second correlated patterns comprises an annular geometry configured to orient said members into a desired rotational alignment.
